(19) United States
(12) Patent Application Publication
(10) Pub. No.: US 2006/0207409 A1
(43) Pub. Date: Sep. 21, 2006

(54) Control of functions and sounds using electronic hand glove

(75) Inventor: Jordan Steven Kavana, Miami, FL (US)

Correspondence Address: AKERMAN SENTERFITT, P.O. BOX 3188, WEST PALM BEACH, FL, 33402-3188, US

(73) Assignee: K Group Industries (Far East) Ltd., Miami, FL (US)

(21) Appl. No.: 11/082,484

(22) Filed: Mar. 17, 2005

(51) Int. Cl. G10H 1/00

(52) U.S. Cl. 84/600

(57) ABSTRACT

An apparatus for remotely controlling a selectively operable device is provided. The apparatus includes a glove assembly (102) comprising a material (104) worn on a hand. The apparatus also includes sensors (116a-d) mounted to the glove assembly (102), each of the sensors generating at least one response signal in response to a movement of the hand or a flexing of a finger of the hand. The apparatus also includes a control circuit (106) mounted to the glove assembly (102) and communicatively connected to the sensors (116a-d) for generating at least one control instruction in response to the response signals. The apparatus further includes a signal transmitter (108) mounted to the glove assembly (102) and communicatively connected to the control circuit (106) for transmitting a wireless signal containing the at least one control instruction, the at least one control signal causing the device to perform at least one predefined electromechanical function.

### BACKGROUND

1. Field of the Invention

The present invention is related to the field of electronic devices, and, more particularly, to the control of electronic devices.

2. Description of the Related Art

Electronic devices are a ubiquitous feature of modern life, various such devices performing an ever-increasing number of different functions. Electronic toys, for example, can be remotely controlled to perform a variety of different play-related functions. A gas-powered, propeller-driven toy airplane, for example, can be made to fly according to a remotely controlled pattern using wirelessly transmitted electronic instructions. Similarly, a propeller-driven toy ship can be steered using a remotely controlled rudder. In many instances, however, the apparatus for control can be a bulky device that may utilize a bewildering array of knobs, dials, or other mechanisms for effecting control. Moreover, the various control apparatus may vary widely in operation and appearance among different types of toys.

Electronics similarly can be employed to enable toys to make various sounds. These sounds encompass, for example, the sound of crying for a toy doll, the sound of an igniting rocket for a toy spacecraft, the sound of horn for a toy automobile, and the sounds of various musical notes for a toy musical instrument. With respect to both the performance of functions and evocation of sounds, however, many toy devices do not enable a child's controlling which functions are performed or which sounds are played. Nor, in many instances, is the child able to control remotely the order in which different various functions are performed or sounds are played by the toy. That is, the toy is limited to performing pre-selected functions and playing pre-selected sounds in a pre-designated order. Moreover, conventional toys typically constrain a child's play activity and imagination by requiring the child to instigate actions with or evoke sounds from a toy by manually activating a switch, button, or similar such device. Such toys preclude a child's controlling which actions are performed and when, as well as which sounds are heard and when, while playing in a natural, realistic, and coordinated fashion.

### SUMMARY OF THE INVENTION

The present invention provides different apparatus and systems for remotely controlling functions performed and sounds rendered by electronic devices such as toys using simple hand motions and finger flexing.

An apparatus for remotely controlling a selectively operable device according to one embodiment of the present invention can include a glove assembly comprising a material configured to be worn on a hand. The apparatus also can include a plurality of sensors mounted to the glove assembly, each of the plurality of sensors generating at least one response signal in response to movement of the hand and/or flexing of a finger of the hand. The apparatus further can include a control circuit mounted to the glove assembly and communicatively connected to the plurality of sensors for generating at least one control instruction in response to the response signals. Additionally, the apparatus can include a signal transmitter mounted to the glove assembly and communicatively connected to the control circuit. The signal transmitter can transmit a wireless signal containing the at least one control instruction, whereby the at least one control signal causes the selectively operable device to perform a predefined electromechanical function in response thereto.

A system according to another embodiment of the present invention can include at least one selectively operable device having both a signal receiving circuit for receiving a wireless signal and at least one electromechanical assembly for performing a predefined electromechanical function in response to a control instruction. The system further can include a glove assembly that includes a material configured to be worn on a hand. The glove assembly further can include a plurality of sensors mounted to the glove assembly, each of the plurality of sensors generating at least one response signal in response to a movement of the hand and/or a flexing of a finger of the hand. The glove assembly also can include a control circuit mounted to the glove assembly and communicatively connected to the plurality of sensors for generating at least one control instruction in response to the response signals. In addition, the glove assembly can include a signal transmitter mounted to the glove assembly and communicatively connected to the control circuit for transmitting a wireless signal containing the at least one control instruction.

Still another embodiment of the present invention is an apparatus for playing sounds. The apparatus can include a glove assembly comprising a material configured to be worn on a hand. The apparatus also can include a plurality of sensors mounted to the glove assembly, each of the plurality of sensors generating at least one response signal in response a movement of the hand and/or a flexing of a finger of the hand. The apparatus also can include a processor mounted to the glove assembly and communicatively connected to the plurality of sensors for processing the at least one response signal. The apparatus further can include a memory communicatively connected to the processor for storing a data representation of the sounds, and a sound rendering circuit for receiving the data from the memory and rendering the sounds in response to an instruction generated by the processor.

A system according to yet another embodiment of the present invention comprises a system for providing sound renderings associated with a device. The system can include at least one device for which at least one sound associated with the device is rendered. The system also can include an apparatus for rendering the at least one sound. The apparatus can include a glove assembly comprising a material configured to be worn on a hand, and a plurality of sensors mounted to the glove assembly such that each can generate at least one response signal in response to a movement of the hand and/or a flexing of a finger. The apparatus also can include a processor mounted to the glove assembly and communicatively connected to the plurality of sensors for processing the at least one response signal. The apparatus further can include a memory communicatively connected to the processor for storing a data representation of the sounds. The apparatus additionally can include a sound rendering circuit for rendering the sounds based upon the data representations and in response to an instruction generated by the processor.

### BRIEF DESCRIPTION OF THE DRAWINGS

There are shown in the drawings, embodiments which are presently preferred. It is to be understood, however, that the invention is not limited to the precise arrangements and instrumentalities illustrated in the drawings.

FIG. 1 is a schematic diagram of a system for controlling selectively operable devices, according to one embodiment of the present invention.

FIG. 2 is a schematic diagram of an apparatus for controlling one or more selectively operable devices, according to another embodiment of the present invention.

FIGS. 3a-c. are schematic diagrams of a dual-slide switch for effecting signals, according to another embodiment of the present invention.

FIG. 4 is a schematic diagram of a flexion sensing circuit for effecting signals, according to yet another embodiment of the present invention.

FIG. 5 is a schematic diagram of an apparatus for rendering sounds, according to still another embodiment of the present invention.

FIG. 6 is a schematic diagram of a system for rendering of sounds, according to yet another embodiment of the present invention.

### DETAILED DESCRIPTION OF THE INVENTION

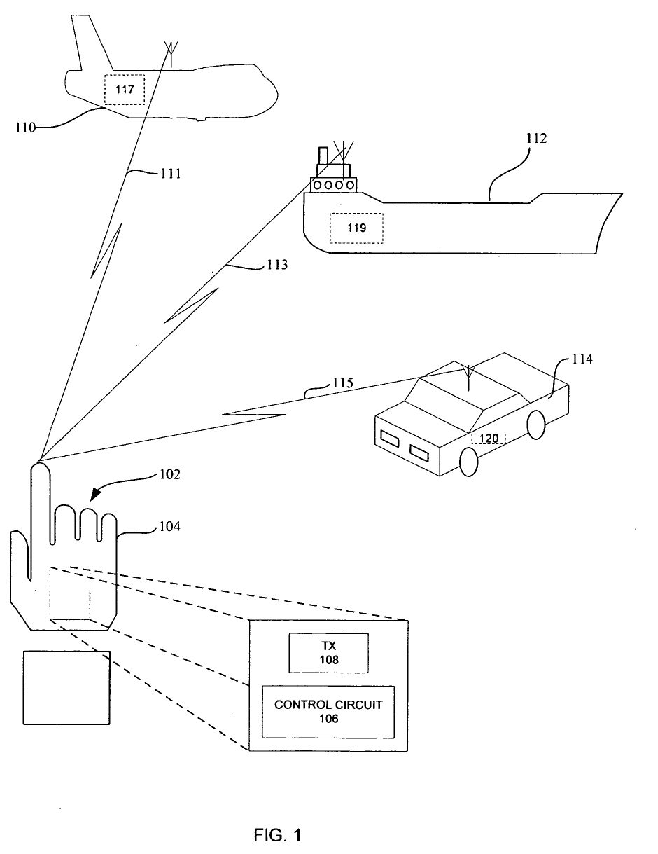

FIG. 1 is a schematic diagram of a system 100 according to one embodiment of the present invention. The system 100 illustratively includes a glove assembly 102 comprising a material 104 configured to be worn on the hand of an adult or child, and circuitry connected therewith for controlling one or more selectively operable devices. More particularly, the circuitry of the glove assembly 102 illustratively comprises a control circuit 106 enmeshed in the material 104 or otherwise mounted to the glove assembly 102. As illustrated, the circuitry of the glove assembly 102 further includes a signal transmitter 108 communicatively connected with the control circuit 106, the signal transmitter 108 also being enmeshed in the material or otherwise mounted to the glove assembly. Illustratively, the selectively operable devices of the system 100 include a toy airplane 110, a toy ship 112, and a toy automobile 114, each of which undertakes movements and/or performs functions as dictated by hand and/or finger movements of a wearer of the glove 102 as explained herein. It is to be understood that the toy airplane 110, toy ship 112, and toy automobile 114 are merely exemplary devices and that similar such selectively operable devices alternatively can form part of the system 100.

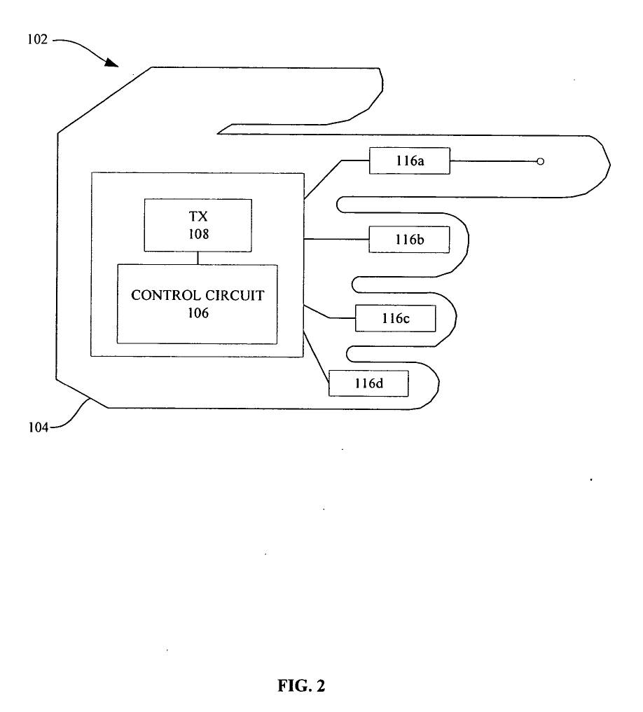

Referring additionally now to FIG. 2, the glove assembly 102 illustratively includes a plurality of movement sensors 116a-d enmeshed in or otherwise mounted to the material 104 of the glove assembly. Illustratively, each of the movement sensors 116a-d is communicatively connected with the control circuit 106 for sensing positional movements of the hand and/or flexion movements of one or more fingers of the hand, and, in response thereto, providing one or more response signals to the control circuit. For each such response signal, the control circuit 106 generates one or more control instructions. Each control instruction is conveyed to one or more of the selectively operable devices of the system 100, which, as already noted, illustratively comprises the toy airplane 110, toy ship 112, and toy automobile 114.

More particularly, the signal transmitter 108 transmits one or more wireless signals to each selectively operable device, each wireless signal being conveyed over a wireless channel 111, 113, 115 and containing one or more of the control instructions generated by the control circuit 106. As will be readily appreciated by one of ordinary skill in the art, the control circuit 106 and the plurality of sensors 116a-d can be powered by a portable power device (not shown), such as a battery, enmeshed in or otherwise connected to the material 104 of the glove assembly 102.

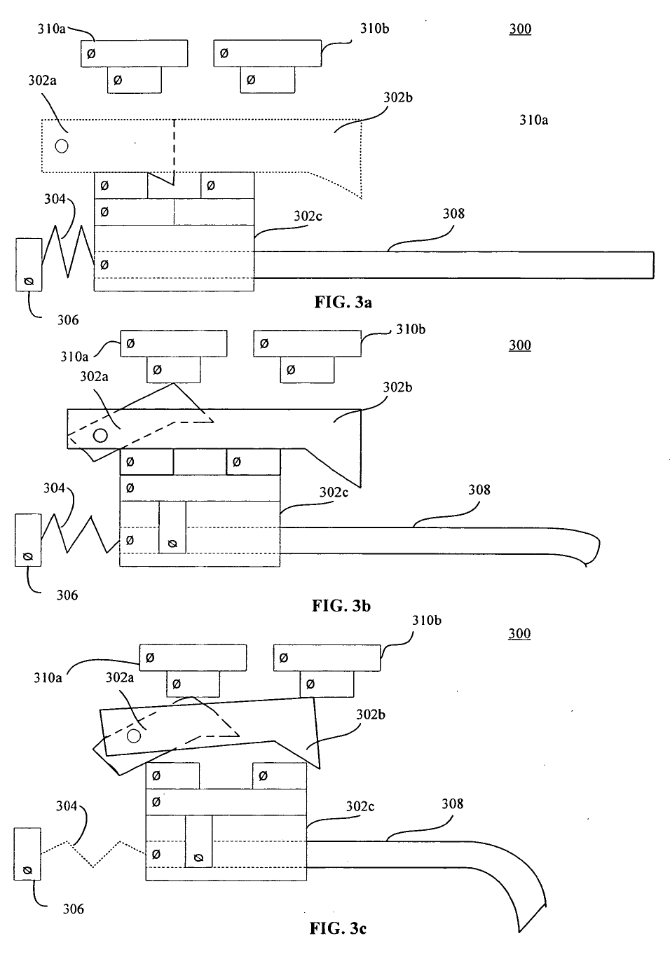

One or more of the movement sensors 116a-d, according to an embodiment illustrated in FIG. 3a, can be implemented using a dual-slide signal actuator 300. Each such dual-slide signal actuator 300 is illustratively positioned in a finger extension of the glove assembly 102. When implemented using a dual-slide signal actuator 300, a movement sensor 116a illustratively includes a pair of spaced-apart signal actuators, defining a first signal actuator 302a and a second signal actuator 302b, as well as an actuator base 302c. The actuator base, in turn, is secured by a spring 304 to a projection 306 secured to the material 104 of the glove 102. The actuator base 302c is mechanically connected to a piping 308 that is connected to the material 104. The piping 308 pulls the actuator base toward the tip of the finger extension whenever a glove wearer flexes a finger inside a finger extension. The spring 304 operates to return the actuator base 302c to a resting position when the finger is no longer flexed.

As illustrated in FIG. 3b, as the wearer of the glove 102 flexes a finger causing the piping 308 to pull the actuator base 302c, a flange portion of the first signal actuator 302a contacts an extended portion of the actuator base and is pivoted upward. As a result, the first signal actuator 302a contacts a first electrical contact 310a of the control circuit 106. The electrical contact results in the conveyance of a first response signal to the control circuit 106.

As additionally illustrated in FIG. 3c, further flexion movement by the wearer of the glove 102 causes the piping 308 to pull the actuator base 302c even further forward. This further movement results in a flange portion of the second signal actuator 302b contacting another extended portion of the actuator base 302c, as illustrated. The second signal actuator 302b pivots upward as a result, thereby contacting a second electrical contact 310b of the control circuit 106. A second response signal results from the contact, the second response signal also being conveyed to the control circuit 106.

Each movement sensor 106a-d implemented with a dual-slide signal actuator 300 yields potentially 22 distinct signal readings, given that each of the pair of signal actuators 302a, 302b has two distinct states depending on whether the particular signal actuator is or is not in contact with a corresponding one of the two electrical contacts 110a, 110b. It will be readily apparent to one of ordinary skill in the art, however, that a greater range of signal readings can be attained by increasing the number of signal actuators beyond the first and second ones illustrated. Accordingly, to effect a greater range of signal readings a multi-slide signal actuator can be used in lieu of the dual-slide signal actuator 300 illustrated, the operative technique of the former being the same as that of the latter. Both types are referred to herein, generically, as slide signal actuators.

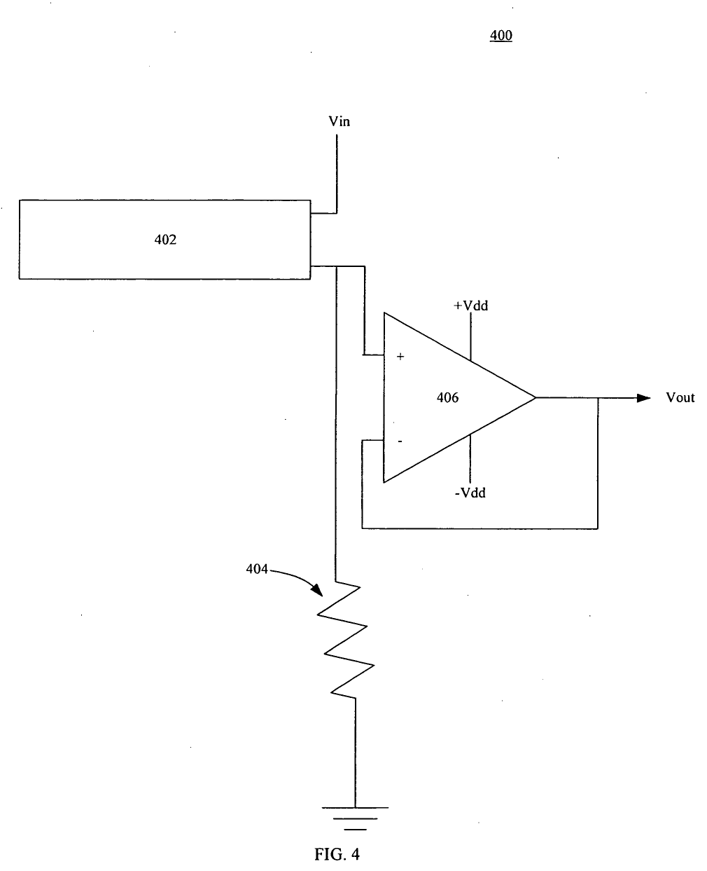

Referring additionally now to FIG. 4, in an alternative embodiment, one or more of the movement sensors 106a-d is implemented using a flex sensor circuit 400 positioned in a finger extension of the glove assembly 102. The flex sensor circuit 400 illustratively comprises a flexion transducer 402 having the property that its resistance varies in relation to the extent to which the flexion transducer is bent. If the flexion transducer 402 has a resistance of X ohms when fully extended, then when flexed to a 90-degree angle the resistance can decrease to 0.30X or 0.40X, for example. According to one embodiment, the flexion transducer 402 of the flex sensor circuit 400 is connected to ground through a fixed-resistance resistor 404. Additionally, the flexion transducer 402 is illustratively connected to an impedance buffer comprising a negative-feedback, operational amplifier (OP AMP) 406, having a voltage range [−Vdd, +Vdd]. The flex sensor circuit 400, for a voltage input Vin, yields a voltage output Vout=Vin[R_{fixed}/(R_{flex}+R_{fixed})], where R_{fixed} is the resistance of the fixed resistance of the resistor 404, and R_{flex} is the variable resistance of the flexion transducer 402. Therefore, since R_{flex} varies depending on the degree to which the flexion transducer 402 is bent, it follows that the flexion movements of a glove wearer's finger cause the voltage output of the flex sensor circuit to change accordingly.

The flexion transducer 402 of the flex sensor circuit can be, for example, a conductive elastomer sensor or a sliding resistor sensor, as will be readily understood by one of ordinary skill in the art. In yet another embodiment, the flexion transducer 402 can comprise a helical coil formed of two interposed electrical conductors that are electrically isolated from one another by an elastic dielectric medium (e.g., an insulated coating over the coils). As the flexion transducer is flexed or bent as a result of the flexing of a finger in the finger extension of the glove 102, the separation between adjacent turns of the helical coil increase, thereby causing a change in capacitance that produces one or more response signals that are supplied to the control circuit 106.

Alternatively, as will also be readily understood by one of ordinary skill in the art, the flexion transducer 402 can comprise a flexible monocrystalline structure defining an acceleration-activated switch that moves in response to an accelerating movement of a glove wearer's hand. More particularly, one or more extensions (e.g., pole tips) can be mounted on the monocrystalline structure as the latter is suspended over one or more planar coils so that a change in inductance or voltage is effected as the moncrystalline structure moves in response to the acceleration and so that the one or more extensions move in the coils. The result is a plurality of distinct response signals that can be supplied to the control circuit 106 as described above.

Thus, regardless of how the plurality of movement sensors 106a-d is implemented, each such movement sensor operationally performs a similar function: it provides at least one response signal in response to a movement of the glove wearer's hand and/or the flexing of a finger of the hand as already described. As also already described, each response signal is the basis for one or more corresponding control instructions generated by the control circuit 106 and conveyed in a wireless signal transmitted by the signal transmitter 108 to one or more selectively operable devices. Therefore, each of various movements and/or positions of the hand and fingers of a wearer of the glove assembly uniquely corresponds to a particular control instruction that is conveyed to a selectively operable device as already described.

The selectively operable devices of the system 100, according to one embodiment, each include an electromechanical mechanism 117, 119, 121 for controlling one or more electromechanical functions that the toy airplane 110, the toy ship 112, and toy automobile 114, respectively, performs in response to a control instruction. For example, the electromechanical mechanism 117 of the toy airplane 110 can be configured to control wing and tail flaps (not shown) on the toy so as to control aerial movements of the toy when it is flown, for example, using a propeller mechanism (also not shown) powered by a gas engine (also not shown). The electromechanical mechanism 119 of the toy ship 112, likewise, can control a rudder (not shown) on the toy as it floats in water and is propelled by a gas engine-driven propeller (also not shown). Similarly, the toy automobile 114 can include a gas-powered motor and drive shaft to propel the toy in a direction dictated by alignment of the toy's wheels under the control of the electromechanical mechanism 121. Again, each of the electromechanical mechanisms is controlled by the control instructions conveyed by the glove assembly 102, which, in turn, controlled by a wearer of the glove assembly.

In each instance, the electromechanical mechanisms 117, 119, 121 further include signal receivers (not shown) for receiving the control instructions generated by the control circuit 106 and contained in the wireless signals conveyed over the wireless channels 111, 113, 115 by the signal transmitter 108 of the glove assembly 102. Since each hand different movement and/or finger flexion movement of a wearer of the glove assembly 102 can correspond to a unique control instruction, the wearer is able to control the movements of the various selectively operable devices of the system 100. As will be readily appreciated by one of ordinary skill in the art, by expanding the functions of the electromechanical mechanisms 117, 119, 121, the various operable devices can be made to perform a wide array of functions, each of which can be controlled by a wearer of the glove assembly 102 in the manner described.

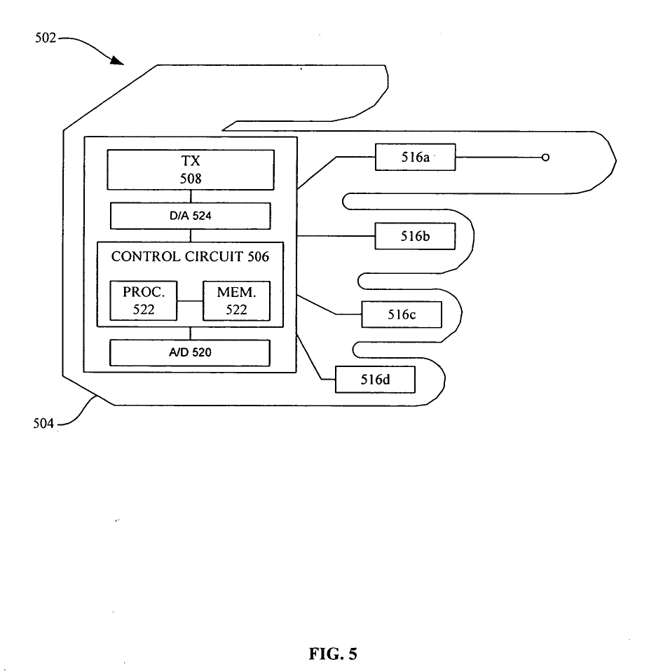

FIG. 5 is a schematic diagram of a glove assembly 502 according to another embodiment of the present invention. The glove assembly 502 illustratively comprises a material 504 configured to be worn on the hand of an adult or child and, enmeshed therein or otherwise supported thereon, a control circuit 506. The glove assembly 502 further illustratively includes a transmitter communicatively linked to the control circuit 506 that is likewise enmeshed in or otherwise supported by the material 504, as well as a plurality of movement sensors 516a-d also enmeshed in or otherwise supported by the material of the glove assembly.

Additionally, the glove assembly 502 illustratively includes an analog-to-digital (A/D) converter 520 that is communicatively connected to the plurality of sensors 516a-d and to the control circuit 506. As further illustrated, the control circuit 506 includes a processor 522, such as a microprocessor, and a memory 524, such as a flash memory, connected with the processor. A digital-to-analog (D/A) converter 526 is illustratively connected to the control circuit 506.

Operationally, each of the plurality of movement sensors 516a-d generates one or more response signals in response to a glove wearer's moving his or her hand and/or flexing one or more of his or her fingers inside a finger extension of the glove assembly 502. The one or more response signals are each converted to a digital signal by the A/D converter 520, each digital signal being supplied to the processor 522 for processing. On the basis of the processing performed by the processor 522, one or more control signals is generated. Each control signal so generated is converted by the D/A converter 526 to a corresponding analog signal. The resulting one or more analog signals can be transmitted over wireless channels 111, 113, 115 to the plurality of selectively operable devices for effecting operative control of each such device.

In accordance with one embodiment, the processor 522 is a programmable processor that can be programmed by a wearer or other user of the glove assembly 502. More particularly, the processor 522 can be programmed on the basis of a set of software-based commands that can be written in a machine-readable form and stored in the memory 524 connected to the processor. For example, according to one scenario, the glove assembly 502 might be worn by a young child for operating one or more toy devices, and the programmable processor could be programmed by the child's parent or other adult.

According to an alternative embodiment, one or more of the electromechanical mechanisms 117, 119, 121 of the plurality of selectively operable devices include a processor and memory for pre-programming a set of responses to the control instructions generated by the control circuit 506 and contained in analog signals transmitted over wireless channels 111, 113, 115 to the plurality of selectively operable devices for effecting remote control of the devices.

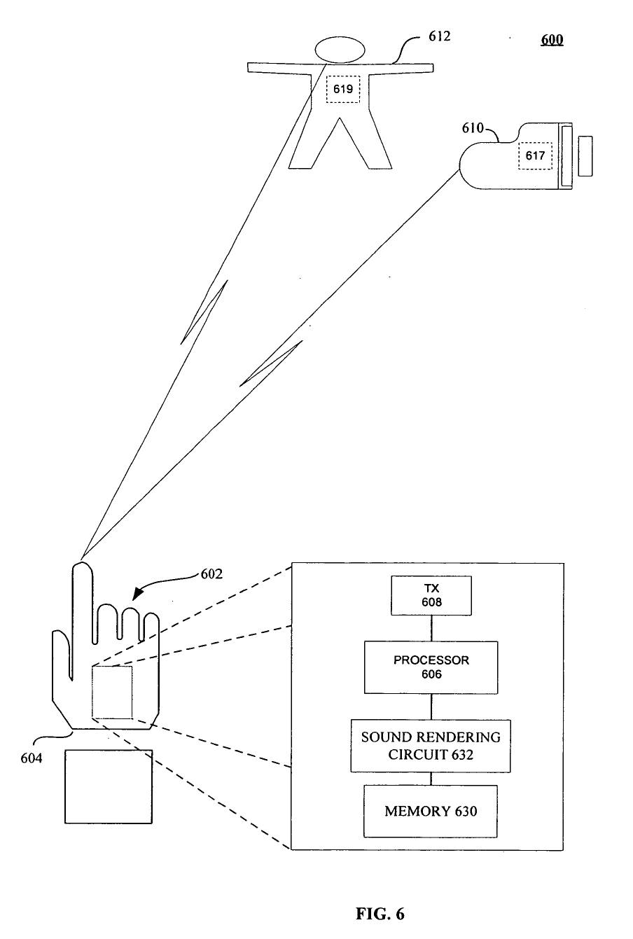

FIG. 6 illustrates a system 600 for rendering sounds, according to still another embodiment of the present invention. The system 600 illustratively includes a glove assembly 602 that remotely controls the generation of sounds in a plurality of selectively operable devices, such as a toy piano 110 and/or a toy doll 112.

As illustrated, the glove assembly 602 includes a material 604 configured to be worn on the hand of an adult or child. A plurality of sensors (not shown) for sensing an accelerating movement of the hand and/or flexion movements of a finger of the hand are enmeshed in or otherwise supported by the material 604. Each sensor generates at least one response signal in response to the accelerating movement and/or flexion movement.

The glove assembly 602 as further illustrated also includes processing circuitry that includes at least one processor 606, such as a microprocessor, enmeshed in or otherwise mounted to the glove assembly 604. The processor 606 is communicatively connected to the plurality of sensors and processes response signals generated by each of the plurality of sensors. A sensor can comprise a signal actuator, a flex sensor circuit including one or more flexion transducers, and/or an acceleration-activated switch, each as described above.

As also illustrated, the glove assembly 602 additionally includes a memory 630, such as a flash memory, communicatively connected to the processor 606. The memory 630 stores data representations of various sounds. Connected to the memory 630 is a sound rendering circuit 632 that receives the data representations from the memory and, based upon the data representation, renders sounds in response to an instruction generated by the processor 606.

As will be readily understood by one of ordinary skill in the art, the data representation of the sounds can comprise machine-readable code that when processed by the processor 606 and supplied to the sound rendering circuit 632 results in the actual acoustic sounds that can be heard by a human listener.

According to one embodiment, the glove assembly 602 further includes a signal transmitter 608 mounted to the glove assembly and communicatively connected to the sound rendering circuit 632 for transmitting a wireless signal containing the sounds to a device, such as the toy piano 610 and the toy doll 612. Illustratively, each device, respectively, include a sound unit 617, 619 comprising a signal receiver and speaker for producing an acoustic signal based upon the wireless signals received. Moreover, according to another embodiment, each such sound unit 617, 619 comprises a detachable unit so that it can be selectively attached to different devices, such as different toys. Thus, even a toy that has no inherently manufactured capacity to produce sounds can be converted into a sound-rendering device by attachment of the sound unit.

In still another embodiment, the sound rendering circuit 632 itself includes a speaker such that the glove assembly 602. Accordingly, the glove assembly 602 itself can be relied upon for rendering sounds associated with a device in lieu of relying on an installed or attached sound unit.

The present invention can be realized in hardware, software, or a combination of hardware and software. The present invention can be realized in a centralized fashion in one computer system, or in a distributed fashion where different elements are spread across several interconnected computer systems. Any kind of computer system or other apparatus adapted for carrying out the methods described herein is suited. A typical combination of hardware and software can be a general purpose computer system with a computer program that, when being loaded and executed, controls the computer system such that it carries out the methods described herein.

The present invention also can be embedded in a computer program product, which comprises all the features enabling the implementation of the methods described herein, and which when loaded in a computer system is able to carry out these methods. Computer program in the present context means any expression, in any language, code or notation, of a set of instructions intended to cause a system having an information processing capability to perform a particular function either directly or after either or both of the following: a) conversion to another language, code or notation; b) reproduction in a different material form.

This invention can be embodied in other forms without departing from the spirit or essential attributes thereof. Accordingly, reference should be made to the following claims, rather than to the foregoing specification, as indicating the scope of the invention.

That claimed is:

1. An apparatus for remotely controlling a selectively operable device, the apparatus comprising:
a glove assembly comprising a material configured to be worn on a hand;
a plurality of sensors mounted to the glove assembly, each of the plurality of sensors generating at least one response signal in response to at least one of a movement of the hand and a flexing of a finger of the hand;
a control circuit mounted to the glove assembly and communicatively connected to the plurality of sensors for generating at least one control instruction in response to the response signals; and
a signal transmitter mounted to the glove assembly and communicatively connected to the control circuit for transmitting a wireless signal containing the at least one control instruction, the at least one control signal causing the selectively operable device to perform a predefined electromechanical function in response thereto.

2. The apparatus of claim 1, wherein at least one of the plurality of sensors comprises a signal actuator.

3. The apparatus of claim 1, wherein at least one of the plurality of sensors comprises flex sensor circuit including at least one flexion transducer.

4. The apparatus of claim 1, wherein at least one of the plurality of sensors comprises an acceleration-activated switch.

5. The apparatus of claim 1, further comprising an analog-to-digital (A/D) converter communicatively connected to the plurality of sensors and to the control circuit for converting each at least one response signal to a corresponding digital signal.

6. The apparatus of claim 5, wherein the control circuit comprises a processor for processing the corresponding digital signal, and further comprising a digital-to-analog (I/A) converter for converting the digital signal to an analog signal comprising the at least control instruction.

7. The apparatus of claim 6, wherein the processor is programmable, the processor being programmed based upon a set of user-supplied instructions.

8. The apparatus of claim 7, further comprising a memory communicatively connected to the processor for storing at least one of a user-supplied processing instruction and a predetermined processing instruction.

9. The apparatus of claim 1, wherein the selectively operable device comprises a plurality of selectively operable devices, and wherein the at least one control instruction comprises a plurality of control instructions for separately controlling the plurality of selectively operable devices.

10. The apparatus of claim 1, further comprising a portable power source mounted to the glove assembly for supplying electrical power to the control circuit and the signal transmitter.

11. A system comprising:
at least one selectively operable device having
a signal receiving circuit for receiving a wireless signal, and
at least one electromechanical assembly for performing a predefined electromechanical function in response to a control instruction; and
a glove assembly comprising:
a material configured to be worn on a hand,
a plurality of sensors mounted to the glove assembly, each of the plurality of sensors generating at least one response signal in response to at least one of a movement of the hand and a flexing of a finger of the hand,
a control circuit mounted to the glove assembly and communicatively connected to the plurality of sensors for generating at least one control instruction in response to the response signals, and
a signal transmitter mounted to the glove assembly and communicatively connected to the control circuit for transmitting a wireless signal containing the at least one control instruction.

12. The system of claim 11, wherein at least one of the plurality of sensors comprises a signal actuator.

13. The system of claim 11, wherein at least one of the plurality of sensors comprises flex sensor circuit including at least one flexion transducer.

14. The system of claim 11, wherein at least one of the plurality of sensors comprises an acceleration-activated switch.

15. The system of claim 11, further comprising an analog-to-digital (A/D) converter communicatively connected to the plurality of sensors and control circuit for converting each at least one response signal to a corresponding digital signal.

16. The system of claim 15, further comprising a digital-to-analog (D/A) converter, and wherein the control circuit comprises a processor for processing the corresponding digital signal, the D/A converter converting the digital signal to an analog signal comprising the at least control instruction.

17. The system of claim 16, wherein the processor is programmable, the processor being programmed based upon a set of user-supplied instructions.

18. The system of claim 16, further comprising a memory communicatively connected to the processor for storing at least one of a user-supplied processing instruction and a predetermined processing instruction.

19. The system of claim 11, wherein the selectively operable device comprises a plurality of selectively operable devices, and wherein the at least one control instruction comprises a plurality of control instructions for separately controlling the plurality of selectively operable devices.

20. The system of claim 11, wherein the glove assembly further comprises a portable power source mounted thereto for supplying electrical power to the control circuit and the signal transmitter.

21. An apparatus for playing sounds, the apparatus comprising:
a glove assembly comprising a material configured to be worn on a hand;
a plurality of sensors mounted to the glove assembly, each of the plurality of sensors generating at least one response signal in response to at least one of a movement of the hand and a flexing of a finger of the hand;
a processor mounted to the glove assembly and communicatively connected to the plurality of sensors for processing the at least one response signal;
a memory communicatively connected to the processor for storing a data representation of the sounds; and
a sound rendering circuit for receiving the data from the memory and rendering the sounds in response to an instruction generated by the processor.

22. The apparatus of claim 21 further comprising a signal transmitter mounted to the glove assembly and communicatively connected to the sound rendering circuit for transmitting a wireless signal containing the sounds to a device spaced apart from the glove assembly.

24. The apparatus of claim 21, wherein the processor comprises a programmable processor.

25. The apparatus of claim 21, wherein the memory comprises a flash memory.

26. The apparatus of claim 21, wherein the data representation comprises machine-readable code.

27. The apparatus of claim 21, wherein the data representation comprises pre-recorded sounds.

28. A system for providing sound renderings associated with a device, the system comprising:
at least one device for which an associated sound is rendered; and
an apparatus for rendering the at least one sound, the apparatus comprising
a glove assembly comprising a material configured to be worn on a hand,
a plurality of sensors mounted to the glove assembly, each of the plurality of sensors generating at least one response signal in response to at least one of a movement of the hand and a flexing of a finger of the hand,
a processor mounted to the glove assembly and communicatively connected to the plurality of sensors for processing the at least one response signal,
a memory communicatively connected to the processor for storing a data representation of the sounds,
a sound rendering circuit for receiving the data from the memory and rendering the sounds in response to an instruction generated by the processor.

29. The system of claim 28, wherein the apparatus further comprises a signal transmitter mounted to the glove assembly and communicatively connected to the sound rendering circuit for transmitting a wireless signal containing the sounds to the at least one device, the at least one device having a signal receiver and speaker for rendering the sound.

30. The system of claim 29, wherein the signal receiver and speaker form an attachable sound unit that can be selectively attached to the at least one device.
